(19) United States
(12) Patent Application Publication
(10) Pub. No.: US 2014/0194033 A1
(43) Pub. Date: Jul. 10, 2014

(54) Device For Creating Wagging Motion Towards Rear of Vehicle

(71) Applicant: John Churchill, Sanibel, FL (US)

(72) Inventor: John Churchill, Sanibel, FL (US)

(21) Appl. No.: 13/737,932

(22) Filed: Jan. 9, 2013

(51) Int. Cl. B60R 11/00

(52) U.S. Cl. CPC B60R 11/00
USPC 446/330

(57) ABSTRACT

Disclosed herein is a device, method, and means for creating a particular motion towards the rear end of an automobile. In some embodiments the device is incorporated with the auto's trailer hitch, the motion is a wagging motion and the visible parts of the device displaying the motion resemble an animal's tail and move in a substantially side to side manner. In other embodiments the motion may be vertical, circular, or constitute extension. The device may attached to any surface or structure towards the rear of the automobile and powered by numerous methods.

### CROSS-REFERENCE TO RELATED APPLICATIONS

N/A

### BACKGROUND OF THE INVENTION

There are numerous tools that have been developed to both facilitate communication on the roadways and for individuals to release tension. Some people use what are referred to as “stress balls”, a pliable material in the shape of a ball design for squeezing with the hand to release tension or stress. Vehicle horns and lights have been used extensively to communicate between drivers. However none of the aforementioned tools have accomplished these tasks simultaneously and in the humorous manner in which the invention disclosed herein does. The following invention allows for an entertaining way to drivers to express themselves, communicate with other drivers, and relieve the tension and pitfalls of road rage.

### FIELD OF THE INVENTION

The invention relates to automobile accessories and communication displays.

### SUMMARY OF THE INVENTION

Disclosed herein is a device, method, and means for creating a particular motion towards the rear end of an automobile. In some embodiments the device is incorporated with the auto's trailer hitch, the motion is a wagging motion and the visible parts of the device displaying the motion resemble an animal's tail and move in a substantially side to side manner. In other embodiments the motion may be vertical, circular, or constitute extension. The device may attached to any surface or structure towards the rear of the automobile and powered by numerous methods. Powering means include electrical from a battery, the car's electrical system, a battery, electricity from wind power or mechanical wind forces. The device essentially attaches to a vehicle, has a means for driving the motion, and has a wide array of possible displays often in the nature of an animal's tail.

### BRIEF DESCRIPTION OF THE DRAWINGS FIGURES

FIG. 1 shows one particular embodiment, the device installed on a pick up truck.

FIG. 2 shows the basic design and fundamental elements of the device in most embodiments.

FIG. 3 shows (i) the basic elements of the motion displayed in most embodiments and (ii) a general description of utilizing wind force to drive the motion.

FIG. 4 shows various examples, not an exhaustive list of the embodiments herein, of positions or styles of the tail portion of the device.

FIG. 5 shows examples of types of designs for the tail portion of the device, in the form of common dog tails.

FIG. 6 shows alternative embodiments of the tail portion of the device.

FIG. 7A is an exterior view of the hitch mount which would slide into place within a hitch on a vehicle. 7B is a series of views of the interior of the hitch mount showing the layout and connection between the motor, 1, and the movable vertical piece, 2.

### DETAILED DESCRIPTION OF THE INVENTION

Overall the device is designed to attach to an automobile and affects a side to side motion of part of the device resembling a tail, the side to side motion being a wagging type motion similar to that of a dog wagging its tail. The device attaches to the rear area of an automobile and has a means of creating or capturing the energy to drive the motion. In some embodiments the device is incorporated into the trailer hitch of an automobile to hold in place.

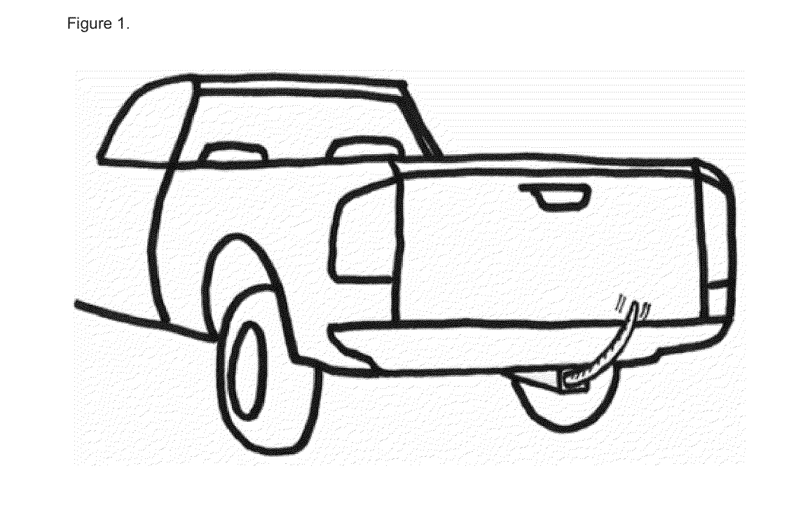

In some embodiments the device is designed to mimic a dog tail or animal tail, and function to mimic the wagging of a tail. FIG. 1 shows one particular embodiment, the device installed on a pickup truck. The “tail portion” of the device is designed to resemble an animal's tail and moves in a manner to depict or imitate a wagging tail.

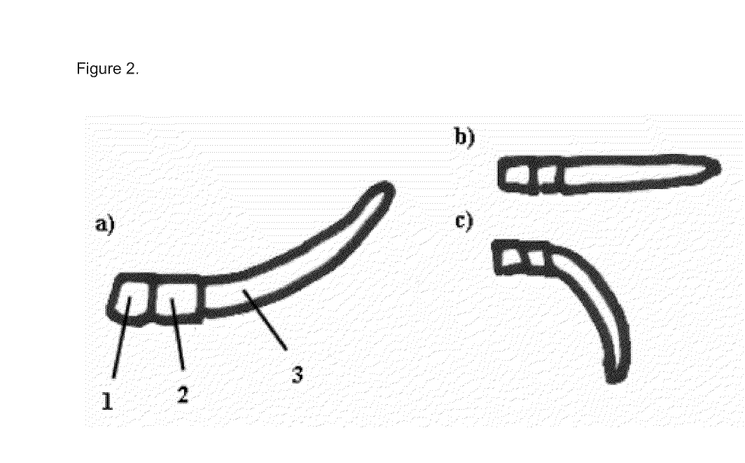

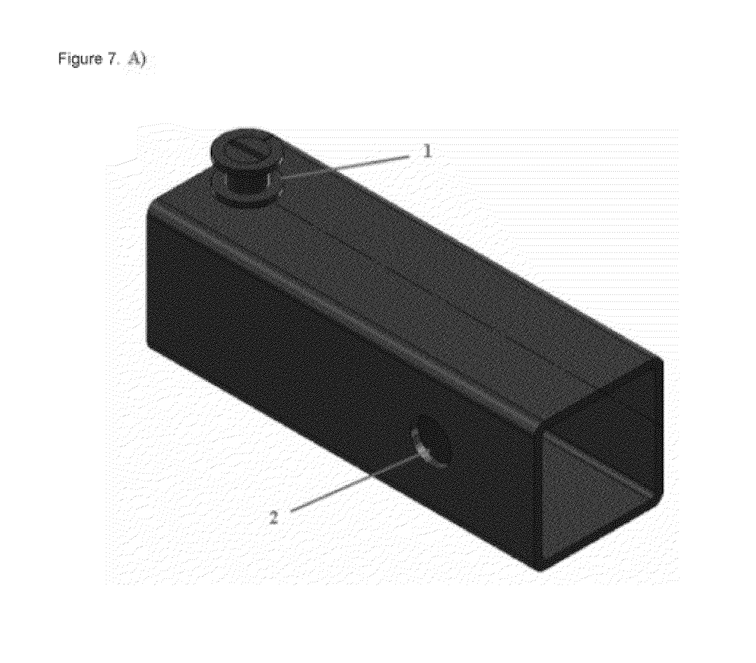

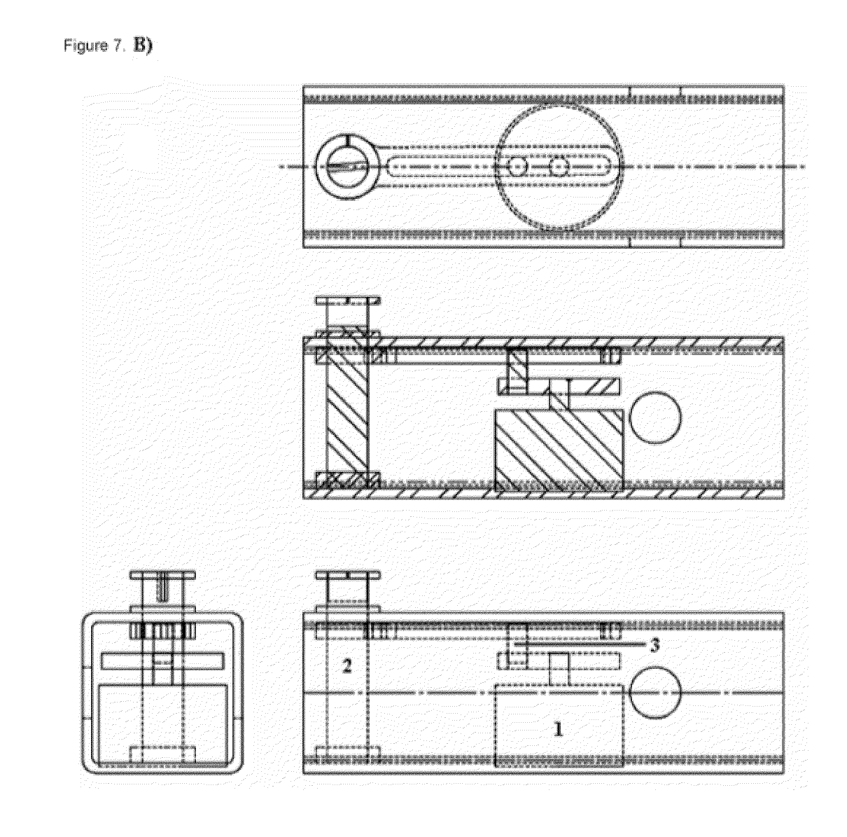

FIG. 2 shows the basic design and fundamental elements of the device in most embodiments. Together, a, b, and c show examples of the tail portions orientation. In a, 1 indicates a means of attachment to a surface or structure towards the back end of an automobile. 2 indicates a means of powering the device, such as a motor or circuitry connecting to an electrical source. 3 points to the “tail portion” which is the part of the device intended to display the motion externally. In many embodiments this portion will resemble an animals tail and move substantially side to side as in a wagging type motion. In some embodiments 1 and 2 may overlap or be combined into a single structure, for example see the design in FIG. 7.

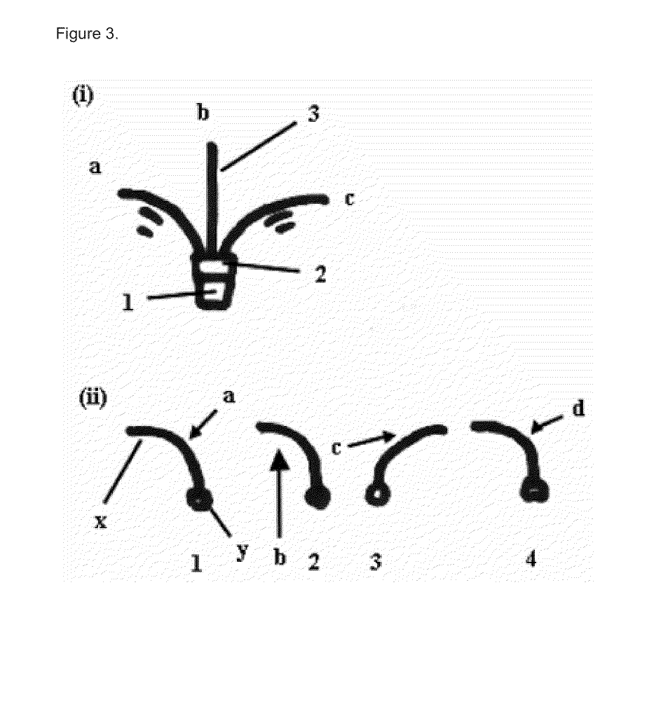

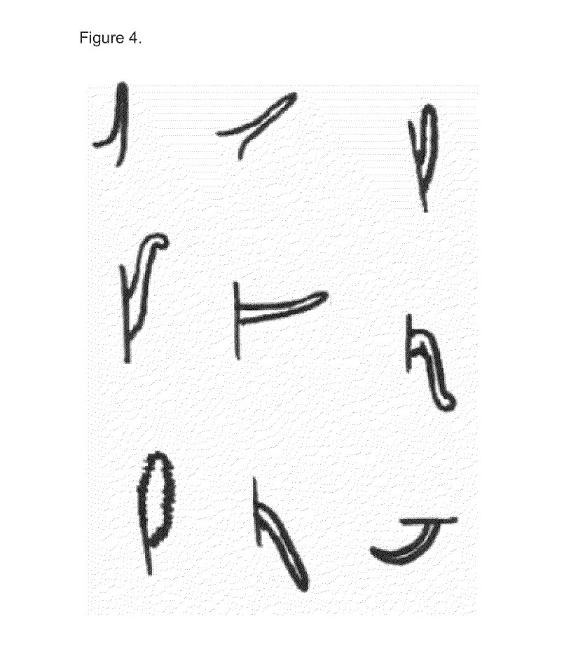

FIG. 3 shows (i) the basic elements of the motion displayed in most embodiments and (ii) a general description of utilizing wind force to drive the motion. In (i) a, b, and c show the different positions of the tail portion, 3, during the wagging motion, moving between a and b and c repeatedly. 1 and 2 show again the potential locations or functional relation of the attachment means, 1, and the driving means or motor, 2.

The device is designed to create a particular motion in the tail end in the likeness of the wagging of a dog or animals tail. The energy to affect the motion, provided by a number of different sources as disclosed herein, results in a part of the overall device, referred to as the “tail end”, “tail portion”, “tail” moving in a side to side or wagging motion. The nature of the overall object of the invention will be understood by those of ordinary skill in the art and is not limited by any particular embodiment, or for example a particular type of animals tail.

A device comprising a portion of the device enabled to perform a wagging motion, a side to side motion, or any motion mimicking the wagging of a tail. Herein, wagging or “wagging motion” refers to motions generally mimicking the wagging of animals tail. Wagging is a side to side type of motion, or brisk and repeated movements from side to side, up and down, or to and fro in combinations thereof. Wagging in some instances may be substantially side to side but need not be exclusively comprised of a horizontal motion. In fact some in some embodiments a tail may move up and downward, or in a circular motion, or may extend itself straight from a first curled position. Tail pieces may also be hanging on different angels of different flexibility. The device is useful for entertainment, auto decoration, and to reduce road rage. The wagging motion may be employed through use of any of a number of power sources. Electrical energy may be used through the use of gears in a number of ways that will be apparent to those skilled in the art. This electrical energy may come from a battery connected or held within the device, or may come through a connection to the electrical system of the automobile, in some embodiments similar to the way in which the lights of a trailer connect with an automobile's electrical system.

Wind energy may also be used by use of a propeller or fan blades and a small wind turbine located somewhere on the auto whereby the wind forces generated by driving are converted into electrical energy to drive the wagging motion of the device. However mechanical wind force may also be used in a number of different ways. In some embodiments a gear system similar to those employed in treadles or hand cars are used to convert a circular motion driven by angled fan blades into a horizontal or side to side motion. This side to side motion constitutes the wagging motion of the tail portion of the device. In other embodiments the tail portion is held in a first position, typically to one side of its range of motion, by a spring or similar device, and is driven from this first position by the force of wind when the automobile moves. A flap connected to a hinge and other schemes may be used to catch the force of the wind and drive the tail portion from the first position, and then the flap may collapse into a position of less wind resistance, the collapsing enabled by the hinges, at which point the force of the spring the pushes the tail portion back to its' first position. Through this repeated process the motion of the wagging of the tail is accomplished.

In (ii), 1, 2, 3, and 4 show the different range of positions of the tail, x, during the wagging motion. An area of the device, y, may contain a spring mechanism that exerts force in one direction, the direction of that force indicated by the arrow a. When a vehicle is in motion the air movement or wind creates a force pushing in another direction, indicated by arrow b. The force continues, arrow c, and as the wind force becomes greater than the force of the spring the tail portion moves into the position shown in 3. The wind force may exert on the tail portion itself, or a flap like structure on a hinge may be employed to create wind sail which then collapses when the tail moves into the position shown in 3, the collapse reducing wind resistance and return the tail to the position shown in 4. In other embodiments the spring may become wound tighter as the tail moves toward the position in 3, exerting more force until it becomes greater than the wind force and thus returning the tail to or near it's original position, shown in 4.

Other embodiments utilizing hinges, fan blades, and gear schemes to capture wind energy will be apparent to those skilled in the art and are included as the object of the invention herein.

In another embodiment a control switch is utilized to electronically connect with and control the device to switch on or off and or regulate speed and other qualities of the wagging motion.

The device is secured to the rear end of an automobile in a number of different ways to a number of different surfaces. For flat surfaces such as the bumper or rear body or trunk a suction cup means may be employed to hold the device in place. Likewise adhesives, such as an adhesive strips, may be used. A magnet or series of magnets may be employed for securing to metal or similarly appropriate surfaces. Clips, overhangs, and the like may be used to secure the device by overhanging the lip of the trunk, or a similarly styled overhanging piece of material held in place by the closing of the trunk lid or tailgate may be used. Many means for securing the device to an automobile including the above as well as bolts, screws, clips, adhesives, fasteners, and the many others apparent to those skilled in the art are part of the disclosure herein. In still other embodiments the device is designed to attach to the ball of a hitch.

In another embodiment the device is incorporated within the trailer hitch to secure it to the automobile. FIG. 7 discloses a hitch mount which may be fit into a hitch. The outer end of the hitch mount connects to a tail portion capable of the wagging motion, side to side movement, and the like consistent with intent of the disclosure. The motion may be accomplished by the elements disclosed in FIG. 7. The motor element drives the shaft at element X, through element 2 in FIG. 7B. The shaft is capable of rotation in both directions and comprises a key part of the tail portion that enables the wagging motion. FIG. 7A is an exterior view of the hitch mount which would slide into place within a hitch on an vehicle. 2 is a pinhole for keeping the hitch mount in place. 1 is a moving vertical piece that is driven by a motor within the hitch mount, in this embodiment, and connects to a tail piece that displays the wagging motion. 7B is a series of views of the interior of the hitch mount showing the layout and connection between the motor, 1, and the movable vertical piece, 2. The movement is affected by a crank assembly, 3, which converts the circular motion of the motor into horizontal movements that allow the vertical piece 2 to create the wagging motion of the tail piece connected to 2.

The motor is powered by any of the means disclosed herein. In some embodiments a battery is connected to the motor and is contained within hitch mount. Further embodiments of this include a circuit in between the battery and motor connected to and controlled by a switch, which may be located in the interior of the auto within arms reach of the driver side seat or driver's vicinity.

Many potentials embodiments are available to employ the actions described herein and will be known to those skilled in the art. In some instances, as in FIG. 7B, a crank may convert a rotary motion to a back and forth motion. The size of the turning wheel and the distance of the wheel from the center of the shaft will alter the reciprocating action. A bell crank employed in the system may convert a circular motion to a side-to-side linear motion. The bell crank can also be used to change an up-and-down linear motion to a side-to-side linear motion if there is no circular wheel driving the crank.

In embodiments where the device is coupled to the electrical system of the auto, many possible alternative embodiments will be apparent to those skilled in the art and are part of the object of the invention here disclosed. For example the device may activated by an auto security or alarm system to trigger the wagging motion when the car alarm is triggered.

The tail portion may be comprised of or covered by any number of materials to affect its appearance and or functionality. The tail may be made of woods, metal, plastics, or any number of other possible embodiments which will apparent to those skilled in the art. Materials to constitute or cover a tail portion may be comprised of cloth, plush, cloth and pile textiles like plush or terry cloth, cotton, nylon, organic cotton/hemp, cotton derivatives, fibres, polyester, polypropylene, fleece, micro-fleece, silk, flannel, denim and other materials apparent to those skilled in the art. The colors and combinations of colors or design patterns such as stripes, spots, and the like are possible for the design of the tail. The qualities of the tail are widely varied, and encompass a range of flexibility, stiff to rigid, for bending and movements of tail structure.

FIG. 4 shows various examples, not an exhaustive list of the embodiments herein, of positions or styles of the tail portion of the device. In some embodiments the tail is a cat tail and movement and expressions typical of cats are employed by the device. FIG. 4 is not limited only to cat tails, however the figure shows many different positions that often typify cat expressiveness.

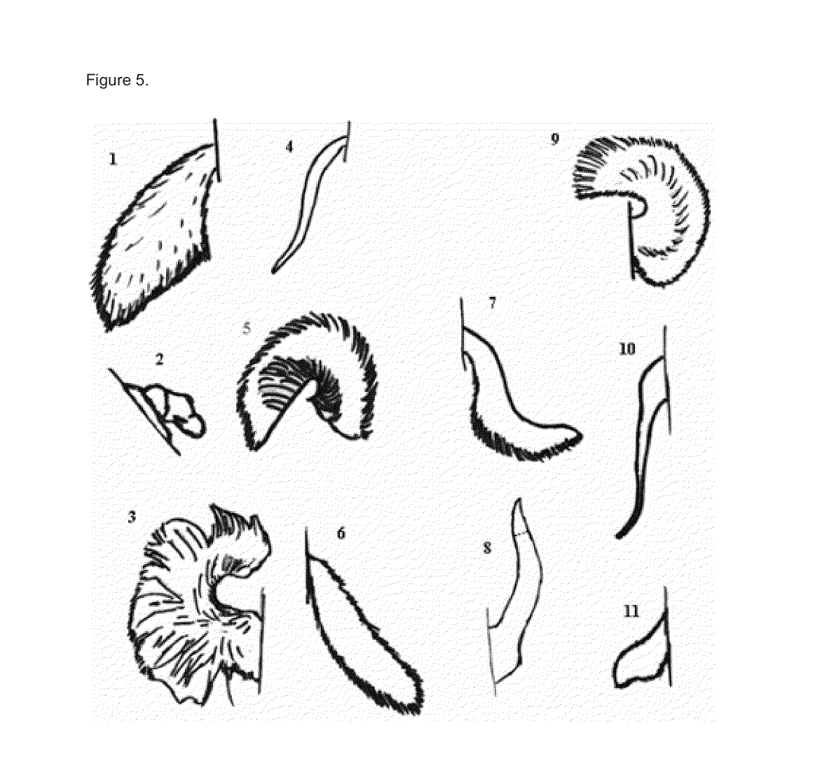

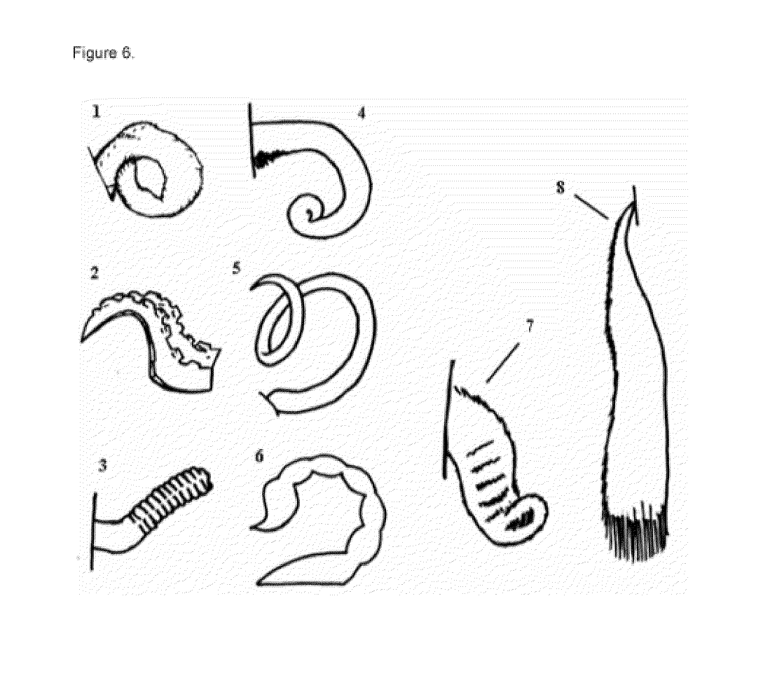

FIG. 5 shows examples of types of designs for the tail portion of the device, in the form of common dog tails. 1 shows a bushy type tail. 2 is bull dog tail. 3 shows a retriever tail, 4 is pitbull tail, 5 is a sickle tail as is characteristic of huskies. 6 is a “natural tail” seen on coyotes or wolves. 7 is a saber tail common among German Shepherds. 8 is a flagpole tail common to beagles. 9 is bushy upwardly curled type of tail seen on many dogs. 10 is a “rat tail” often on Irish Water Spaniel & Afghan breeds. 11 is a docked tail common to boxers. Other types of tails are included as designs for the tail portion including but not limited to crank, curled, doubled curl, gay, otter, plume, ring at end, ring, saber, screw, sickle, snap, squirrel and whip.

The device and design and appearance of the tail portion is not limited to resembling dog tails, and other types of animals tails are given as a non-exhaustive non-limiting list of examples. FIG. 6 shows alternative embodiments of the tail portion of the device. 1 shows a bushy type tail of animal, 2 shows an alligator tail, 3 shows rattlesnake rattle, 4 shows a monkey tail, 5 shows a pigtail, 6 shows scorpion tail or stinger, 7 shows a bobcat tail, and 8 shows a horse tail.

“Tail end” refers to the portion of the device displaying the wagging motion, and may have many different types of appearances and characteristics. “Tail portion” when used herein refers to the portion or parts of the device that move when employed during the wagging motion. “Wagging motion” refers to a generally side to side, however not limited by an exact adherence to horizontal movement. In some embodiments the wagging motion may be circular or vertical in nature.

The phrase “in one embodiment” is used repeatedly. The phrase generally does not refer to the same embodiment; however, it may. The terms “comprising,” “having” and “including” are synonymous, unless the context dictates otherwise. The following illustrations of various embodiments use the term “recipe” by way of example to describe the various embodiments, but this should be construed to encompass and provide for terms such as “method” and “routine” and the like.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description thereof that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the description be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way. The characteristics and utilities of the present invention described in this summary and the detailed description below are not all inclusive. Many additional features and advantages will be apparent to one of ordinary skill in the art given the detailed description.

What is claimed is:

1. A device comprising a portion of the device enabled to perform a wagging motion, a side to side motion, or any motion mimicking the wagging of a tail.

2. The device of claim 1, wherein said device is connected to a power source.

3. The device of claim 2, wherein said power source is a battery connected to the device, a solar panel connected to the device, a wind driven electrical turbine connected to this device, or the electrical system of the car.

4. The device claim 2, wherein the device is connected to a remote switch capable of controlling the wagging motion.

5. The device of claim 1, wherein the wagging motion of the device is driven by mechanical wind force.

6. The device of claim 5, wherein the energy from mechanical wind force is captured by a propeller connected to a gear system, a rudder and hinge system, or a spring which holds the tail portion of the device in a first position and is driven by wind force out of said first position, and returned to said first position by the force of the spring.

7. The device of claim 1, wherein said device is secured to the rear end of an automobile.

8. The device of claim 7, wherein the device is secured by a suction cup, one or more magnets, an adhesive, incorporation with a trailer hitch, an overhang interacting with the rim a car trunk, or a flap secured by a closed trunk or tailgate.

9. A device, a portion of the device capable of a wagging motion, said device comprising means for attaching to an automobile and means for driving the wagging motion.

10. claim 9, wherein said means for driving the wagging motion is one of either electrical energy from a solar panel, electrical energy from a wind turbine, electrical energy from a battery, electrical energy drawn from the electrical system of the automobile, or mechanical wind force.

11. A device, incorporated within a hitch mount, comprising a motor, a crank, and a shaft attached to a tail portion wherein the motor affects a wagging motion in the tail portion.

12. The device of claim 11 further comprising a switch breaking or join the electrical circuit to control the wagging motion of the device.

13. The device of claim 12, wherein the switch is located within the cab of the vehicle.
